(19) United States
(12) Patent Application Publication
(10) Pub. No.: US 2023/0249197 A1
(43) Pub. Date: Aug. 10, 2023

(54) METHOD FOR FLOTATION OF A SILICATE-CONTAINING IRON ORE

(71) Applicant: BASF SE, Ludwigshafen (DE)

(72) Inventors: Alexej Michailovski, Ludwigshafen (DE); Gabriela Budemberg, Jacarei (BR); Bettina Sobotka, Lampertheim (DE); Radoslaw Kierat, Ludwigshafen (DE)

(21) Appl. No.: 18/015,645

(22) PCT Filed: Aug. 10, 2021
(86) PCT No.: PCT/EP2021/072215

§ 371 Date: Jan. 11, 2023

(30) Foreign Application Priority Data
Aug. 11, 2020 (EP) 20190413.3

(51) Int. Cl. B03D 1/01

(52) U.S. Cl. CPC B03D 1/01; B03D 2201/02; B03D 2203/04

(57) ABSTRACT

Described herein are methods for manufacturing a concentrate enriched in iron mineral content from an ore, which contains an iron mineral and silicate, by a reverse flotation. The method includes adding a first amine to a prepared aqueous pulp of the ore and optionally one or more flotation auxiliaries to obtain an aqueous mixture. The first amine (A) may be a compound of formula I

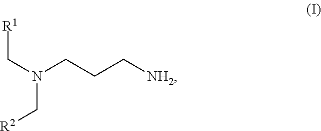

a salt of a protonated compound of formula I and a first anion or a mixture thereof. A second amine, which is a compound of formula II

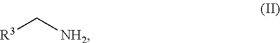

a salt of a protonated compound of formula II and a second anion or a mixture thereof, can be further added. Further described herein are specific compositions of the first amine (A) and the second amine (B) for a use as a flotation collector.

### CLAIM OF PRIORITY

This application is a National Stage of International Application No. PCT/EP2021/072215, filed Aug. 10, 2021, which claims the benefit of European Patent Application No. 20190413.3 filed Aug. 11, 2020, which is incorporated by reference herein.

### DESCRIPTION

The present invention relates to a method for manufacturing a concentrate enriched in iron mineral content from an ore, which contains an iron mineral and silicate, by a reverse flotation using a first amine and particularly a mixture of the first amine and a second amine. A further embodiment is a use of the first amine as a flotation collector, particularly of the mixture of the first amine and the second amine as a flotation collector, and a composition of the first amine and the second amine as a flotation collector.

A typical iron ore beneficiation process requires a flotation stage to remove silica (SiO₂) from the valuable iron mineral, e.g. oxides like hematite or magnetite, and thus to obtain a high-grade iron mineral concentrate. A high-grade iron mineral concentrate allows to make high quality steel. Removal of SiO₂ from different ores by froth flotation in combination with hydrophobic amines is a well-known process. Negatively charged silicate particles can be hydrophobized using suitable amines. Injection of air in a flotation cell leads to formation of hydrophobic gas bubbles, which can transport the hydrophobized silicate particles to the top of the flotation cell. The formed froth, which can be stabilized by a suitable chemical acting as a froth regulator, contains the hydrophobized silicate particles. Finally, the froth will be removed from the top and the enriched mineral is left at the bottom of the flotation cell.

GB 578695 relates to mineral concentrations and a class of reagents for selectively separating acidic minerals from other ore constituents. The reagents for froth flotation are represented by a compound of one of the following general formulae

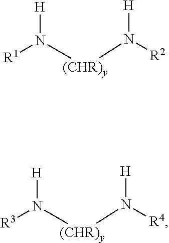

wherein y is an integer from 2 to 12, R is hydrogen or an alkyl group, R¹ is an alkyl group having from 8 to 30 carbon atoms, or a carboxylic acyl group having from 8 to 32 carbon atoms, R² is hydrogen or an alkyl group having from 8 to 30 carbon atoms or an alkylol ester or aralkyl group, R³ is a carboxylic acyl group having from 8 to not more than 32 carbon atoms and R⁴ is an alkyl, alkylol, alkylol ester or aralkyl group or of a salt of such a compound. Test No. 2 discloses a phosphate rock flotation with N-lauryl ethylene diamine hydrobromide and pine oil. A treatment of iron ores for removing silica is mentioned.

DE 1173041 relates to a flotation of oxidic minerals with aliphatic amines as collectors, which are branched aliphatic primary amines having at least 6 carbon atoms and their water-or oilsoluble salts alone or with usual collecting, foaming or regulating auxiliaries. Example 1A discloses a flotation of zinc carbonate and/or zinc phosphate with 2-ethylhexylamine acetate and sodium sulfide. Example 3 discloses a flotation of zinc carbonate and/or zinc silicate with a mixture of 2-ethylhexylamine acetate and 2-ethylhexylamine, an ethoxylated fatty alcohol as an emulgator and sodium sulfide.

EP 0174866 relates to collectors and a process for recovering meal values from a metal ore by subjecting the metal ore, in the form of an aqueous pulp, to a froth flotation process in the presence of a collector, wherein the collector comprises a compound corresponding to the formula

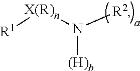

wherein R is —CH₂—, —CH(OH)—, —CO—, or a combination thereof and n is an integer from 1 to 6 or —(R)ₙ— is —(CH₂)ₘ—C≡, where m is an integer from 0 to 6, R¹ and each R₂ are independently C₁₋₂₂ hydrocarbyl or a C₁₋₂₂ hydrocarbyl substituted with one or more hydroxy, amino, phosphonyl, alkoxy, imino, carbamyl, carbonyl, thiocarbonyl, cyano, carboxyl, hydrocarbylthio, hydrocarbyloxy, hydrocarbylamino or hydrocarbylimino groups, with some provisos. Example 1 discloses a froth flotation of a chalcopyrite copper sulfide ore with inter alia N′,N′-dibutylethane-1,2-diamine, N′,N′-diethylethane-1,2-diamine or N′,N′-dihexylethane-1,2-diamine and Dowfroth 250 as a frother. Example 4 discloses a froth flotation of a chalcopyrite copper sulfide ore with inter alia N′,N′-dibutylethane-1,2-diamine and Dowfroth as a frother. Example 6 discloses a froth flotation of a nickel/cobalt ore with inter alia N′,N′-dibutylethane-1,2-diamine and a frother, e.g. triethoxybutane.

US 2015-0096925 relates to collector compositions and methods for making and using same to purify one or more crude materials. The collector composition can include one or more amidoamines having the formula as depicted below

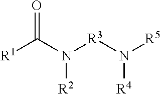

and one or more amines having the formula R⁶—NH₂, where a weight ratio of the amidoamine to the amine can be about 99:1 to about 1:99. In its example 1, a coconut fatty acid diethylenetriamine amidoamine neutralized with glacial acetic acid is used in an inverse flotation of a phosphate ore for removal of silica at a neutral pH. In its example 2, a coconut fatty oil diethylenetriamine amidoamine neutralized with glacial acetic acid is used in an inverse flotation of a phosphate ore for removal of silica at a neutral pH. In its example 3, a tall oil fatty acid diethylenetriamine neutralized with glacial acetic acid is used for an inverse flotation of a phosphate ore for removal of silica at a neutral pH. Other amidoamines similarly employed are lauric acid diethylenetriamine amidoamine and a rosin acid tetraethylenepentamine amidoamine. Some example provide also a combination of an amidoamine with an amine such as an etheramine composed of 95 wt. % of 3-(8-methylnonoxy)propan-1-amine and 3 wt. % of 8-methylnonan-1-ol, such as cocoamine or such as dodecylamine.

F. Nakhaei et al in Miner. Process. Extr. Metall. Rev. (2017) discloses types of amine collectors commonly used in iron flotation, which include fatty diamines.

U.S. Pat. No. 3,817,972, EP 0174866, GB 578695 and U.S. Pat. No. 4,797,202 all disclose as well amine derivatives used in flotation, however none of those disclosed are types of amine collectors according to the present invention for use in flotation.

Although US 2020/172767 discloses a dispersion composition containing an approximately 50:50 mixture of n-hexylamine and N,N-diethyl-1,3-diaminopropane, and comprising additionally terpineol and silver particles, said composition is used as an electroconductive adhesive composition and is therefore not suitable for the purpose of the present invention.

There is still a need for improved methods in inverse flotation of ores containing iron mineral and silicate. Especially the quality of ores has been decreasing. With higher SiO₂ content in the ore, a selective removal of silicate is more difficult than in the past with ores of a lower SiO₂ content. On one side, a loss of iron mineral in the flotation process should be avoided, i.e. a high recovery, and on the other side, SiO₂ content should be decreased in a concentrate enriched in iron mineral content to a low level, i.e. selectivity. Especially for direct reduction processes using the concentrate, a low SiO₂ content is desirable. Typically, a mine as an ore processing site will set a maximum level of residual SiO₂ content that is allowed to remain in the concentrate at the end of the flotation process. This may for instance be 2.5% by weight, especially 2.0% by weight. The target is generally to at least achieve this maximum silica level without significantly losing any of the iron mineral content. A better recovery in combination with a comparable or a better selectivity reduces iron mineral losses in the tailings and leads to economic benefits.

It is an object of the present invention to provide a method for manufacturing a concentrate enriched in iron mineral content with a high recovery of iron mineral from the applied ore and a low content of SiO₂ from the applied ore. Furthermore, it is attractive if an employed collector allows to reduce or even abstain from a necessity for a specific flotation auxiliary. At the same time, it is an advantage if a material applied in the method can economically be manufactured in a chemically relatively pure and thus homogenous form, for example because less side reactions can occur. A chemically relatively pure material offers via combination with other materials, particularly other co-collectors, a fine-tuned adjustment to a specific ore.

The object is achieved, according to the invention, by a method for manufacturing a concentrate enriched in iron mineral content from an ore, which contains an iron mineral and silicate, by a reverse flotation, which method comprises the step of
(c) adding a first amine to a prepared aqueous pulp of the ore and optionally one or more flotation auxiliaries to obtain an aqueous mixture,
characterized in that the first amine is
(A) a compound of formula I

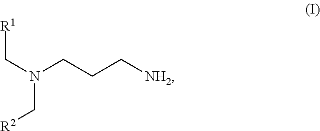

wherein R¹ and R² are independently from each other methyl, ethyl, propyl, 1-methyl-ethyl, butyl, pentyl, hexyl, heptyl or 2-methyl-hexyl, a salt of a protonated compound of formula I and a first anion or a mixture thereof.

Preferably, the method for manufacturing a concentrate enriched in iron mineral content from an ore, which contains an iron mineral and silicate, comprises the steps of
(a) providing the ore, which contains an iron mineral and silicate,
(b) preparing from the provided ore by addition of water and optionally one or more flotation auxiliaries an aqueous pulp,
(c) adding a first amine to the prepared aqueous pulp of the ore and optionally one or more flotation auxiliaries to obtain an aqueous mixture, characterized in that the first amine is
   (A) a compound of formula I

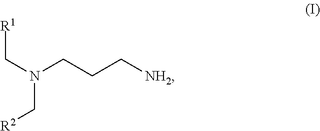

wherein R¹ and R² are independently from each other methyl, ethyl, propyl, 1-methyl-ethyl, butyl, pentyl, hexyl, heptyl or 2-methyl-hexyl, a salt of a protonated compound of formula I and a first anion or a mixture thereof,
(d) aerating the aqueous mixture in a flotation cell to generate a froth, which is enriched in silicate content, and removing the generated froth from the flotation cell,
(e) obtaining from the flotation cell the concentrate enriched in iron mineral content.
   The steps (a), (b), (c), (d) and (e) describe more detailed the reverse flotation.

Preferably, a second amine is further added at step (c), which is
(B) a compound of formula II

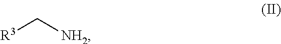

wherein R³ is a C₅-C₁₇ alkyl, which is branched or linear, or a C₅-C₁₇ alkenyl, which is branched or linear, a salt of a protonated compound of formula II and a second anion or a mixture thereof.
   The ore, which contains an iron mineral and silicate (SiO₂), is for example from a magmatic deposit or from a sedimentary deposit. The step (a) of providing an ore results in a provided ore. The step (a) of providing an ore comprises for example a crushing and/or a grinding of the ore. In case of an ore from a magmatic deposit, the step of providing the ore comprises for example also a crushing of the ore and a grinding of the ore. In case of an ore from a sedimentary deposit, the step of providing the ore comprises for example a crushing of the ore, particularly a crushing of the ore and a wet grinding of the ore. A grounded and/or crushed ore is in the form of particles. At the step (a) of providing of the ore, magnetic parts of the ores can be removed by a magnetic treatment, preferably once the ore has been grounded and/or crushed and is in the form of particles. A correlation herein to a weight of the ore or weight parts of the ore refers to dry ore. Preferably, the step (a) of providing of the ore results in a provided ore, which is in the form of particles. Preferably, the provided ore is in the form of particles, which have a particle size allowing 60 wt. % to 100 wt. % of the particles based on the overall weight of the provided ore to pass a 100 μm steel mesh sieve as measured by standard dry sieving. Preferably, the step (a) of providing of the ore results in a provided ore, which is in the form of particles and more than 90 wt. % of the particles have a particle size of 150 μm or below. Very preferably, the step (a) of providing of the ore results in a provided ore, which is in the form of particles, more than 90 wt. % of the particles have a particle size of 150 μm or below and more than 80 wt. % of the particles have a particle size of 106 μm or below. Particularly, the step (a) of providing of the ore results in a provided ore, which is in the form of particles, more than 90 wt. % of the particles have a particle size of 150 μm or below, more than 80 wt. % of the particles have a particle size of 106 μm or below and more than 30 wt. % of the particles have a particle size of 38 μm or below. Very particularly, the step (a) of providing of the ore results in a provided ore, which is in the form of particles, more than 92 wt. % of the particles have a particle size of 150 μm or below, more than 82 wt. % of the particles have a particle size of 106 μm or below and more than 35 wt. % of the particles have a particle size of 38 μm or below.

The ore contains preferably 20 wt. % to 65 wt. % iron atoms based on the overall weight of the ore. The weight content of iron atoms (Fe atoms) is similar to an iron content in weight. The content of iron atoms is determined for example by WDXRF. The ore contains very preferably 25 wt. % to 55 wt. % of iron atoms, particularly 30 wt. % to 50 wt. % and very particularly 35 wt. % to 47 wt. %. An iron mineral is for example an iron oxide. Typical iron oxides are hematite (Fe₂O₃ with 69.9% by weight of iron content), magnetite (Fe₃O₄ with 72.4% by weight of iron content), goethite (Fe(0)OH with 62.9 by weight of iron content) or a mixture thereof. Preferably, the iron mineral consists out of less than 10 wt. % of an iron sulfide based on the overall weight of all iron minerals in the ore. Very preferably, all iron minerals in the ore are non-sulfidic iron minerals. The iron minerals in the ore consists preferably out of 90 wt. % to 100 wt. % of iron oxide based on the overall weight of all iron minerals in the ore. Very preferably, the iron minerals in the ore consists out of at least 97 wt. % to 100 wt. % of iron oxide, particularly out of 99 wt. % to 100 wt. %.

The ore contains preferably 20 wt. % to 65 wt. % iron atoms and 20 wt. % to 70 wt. % of silicate calculated as SiO₂, very preferably 25 wt. % to 55 wt. % iron atoms and 25 wt. % to 55 wt. % of silicate calculated as SiO₂, particularly 30 wt. % to 50 wt. % iron atoms and 30 wt. % to 45 wt. % of silicate calculated as SiO₂ and very particularly 35 wt. % to 47 wt. % iron atoms and 32 wt. % to 43 wt. % of silicate calculated as SiO₂.

A typical ore comprises 40 wt. % to 70 wt. % of hematite and 30 wt. % to 50 wt. % of silicate calculated as SiO₂, particularly 45 wt. % to 65 wt. % of hematite and 30 wt. % to 45 wt. % of silicate calculated as SiO₂. Preferably, more than 50 wt. % of the iron mineral, which is contained in the ore, is an iron oxide, which is hematite. Very preferably, 70 wt. % to 100 wt. % of the iron mineral, which is contained in the ore, is an iron oxide, which is hematite.

Preferred is a method, wherein the ore contains iron atoms in the range of 20 wt. % to 55 wt. % based on the weight of the ore.

The compound of formula I and the compounds of formula II act in the method as a collector for froth flotation.

The first amine (A) comprises also a mixture of two or more compounds of formula I. Preferably, R¹ and R² are independently from each other methyl, ethyl, propyl, 1-methyl-ethyl, butyl or pentyl. Very preferably, R¹ and R² are independently from each other methyl, ethyl, propyl or 1-methyl-ethyl. Particularly, R¹ and R² are independently from each other methyl, propyl or 1-methyl-ethyl. Very particularly, R¹ and R² are independently from each other methyl or propyl. Preferably, R¹ and R² are the same. Very preferably, R¹ and R² are the same and methyl, ethyl, propyl, 1-methyl-ethyl, butyl or pentyl. Particularly, R¹ and R² are the same and methyl, ethyl, propyl or 1-methyl-ethyl. Very particularly, R¹ and R² are the same and methyl, propyl or 1-methyl-ethyl. Especially, R¹ and R² are the same and methyl or propyl. Very especially, R¹ and R² are propyl.

A compound of formula I, wherein R¹ and R² are propyl, is N′,N′-dibutylpropane-1,3-diamine and is depicted below

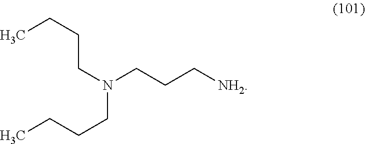

A compound of formula I, wherein R¹ and R² are methyl, is N′,N′-diethylpropane-1,3-diamine and is depicted below

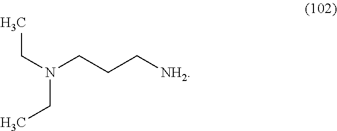

A compound of formula I, wherein R¹ and R² are ethyl, is N′,N′-dipropylpropane-1,3-diamine and is depicted below

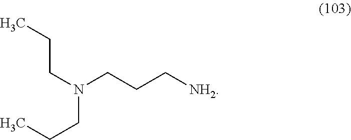

A compound of formula I, wherein R¹ and R² are 1-methyl-ethyl, is N′,N′-diisobutylpropane-1,3-diamine and is depicted below

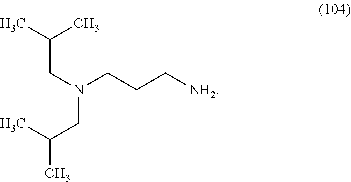

A compound of formula I, wherein R¹ and R² are butyl, is N′,N′-dipentylpropane-1,3-diamine and is depicted below

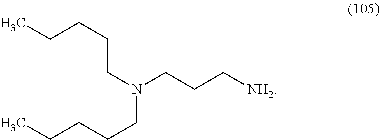

A compound of formula I, wherein R¹ and R² are pentyl, is N′,N′-dihexylpropane-1,3-diamine and is depicted below

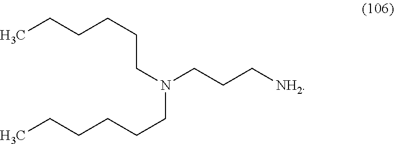 [SMILES: CCCCCCN(CCCN)CCCCCC]

A compound of formula I, wherein R¹ and R² are hexyl, is N′,N′-diheptylpropane-1,3-diamine and is depicted below

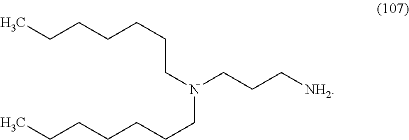 [SMILES: CCCCCCCN(CCCN)CCCCCCC]

A compound of formula I, wherein R¹ and R² are heptyl, is N′,N′-dioctylpropane-1,3-diamine and is depicted below

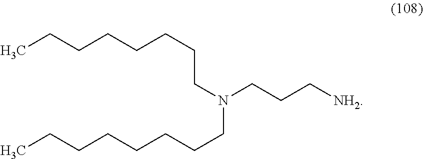 [SMILES: CCCCCCCCN(CCCN)CCCCCCCC]

A compound of formula I, wherein R¹ and R² are 2-methyl-hexyl, is N′,N′-bis(3-methylheptyl)propane-1,3-diamine and is depicted below

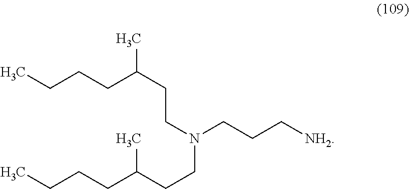 [SMILES: CCCCC(C)CCN(CCCN)CCC(C)CCCC]

A compound of formula I, wherein R¹ is propyl and R² is methyl, is N′-butyl-N′-ethylpropane-1,3-diamine and is depicted below

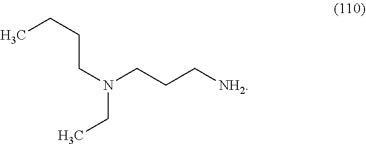

Preferred is a method, wherein R¹ and R² are independently from each other methyl, ethyl, propyl, 1-methyl-ethyl, butyl or pentyl.

Preferred is a method, wherein R¹ and R² are the same.

Preferred is a method, wherein R¹ and R² are propyl.

The second amine (A) comprises also a mixture of two or more compounds of formula II. R³ is for example pentyl, hexyl, heptyl, 1-ethyl-pentyl, octyl, iso-octyl, nonyl, iso-nonyl, decyl, iso-decyl, undecyl, iso-undecyl, dodecyl, iso-dodecyl, tridecyl, iso-tridecyl, tetradecyl, isotetradecyl, pentadecyl, iso-pentadecyl, hexadecyl, iso-hexadecyl, heptadecyl, iso-heptadecyl, dec-9-en-yl or (Z)-heptadec-8-en-yl. Preferably, R³ is C5-C12 alkyl, which is branched or linear, or a C10-C17 alkenyl, which is branched or linear. Very preferably, R³ is C5-C12 alkyl, which is branched or linear, or C17 alkenyl, which is linear. Very particularly, R³ is C5-C12 alkyl, which is branched or linear. Especially, R³ is C5-C9 alkyl, which is branched or linear. Very especially, R³ is C6-C8 alkyl, which is branched or linear. More especially, R³ is C7 alkyl, which is branched. Most especially, R³ is 1-ethyl-pentyl.

A compound of formula II, wherein R³ is 1-ethyl-pentyl, is 2-ethylhexan-1-amine and is depicted below

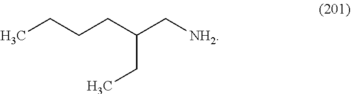

A compound of formula II, wherein R³ is pentyl, is hexan-1-amine and is depicted below

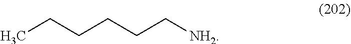

A compound of formula II, wherein R³ is heptadecyl, is octadecan-1-amine and is depicted below

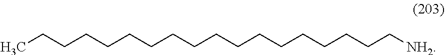 [SMILES: CCCCCCCCCCCCCCCCCCN]

A compound of formula II, wherein R³ is (Z)-heptadec-8-en-yl, is (Z)-octadec-9-en-1-amine and is depicted below

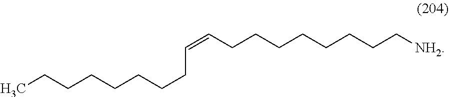 [SMILES: CCCCCCCC/C=C\CCCCCCCCN]

Preferred is a method, wherein R³ is a C7-C12-alkyl, which is branched or linear.

Preferred is a method, wherein R³ is 1-ethyl-pentyl.

Preferred is a method, wherein R¹ and R² are propyl and R³ is 1-ethyl-pentyl.

The first anion is the deprotonated form of an acid A′(-H)p, wherein —H represents an acidic proton and p the number of acidic protons of the acid A′(-H)p. Depending on the acid strength of the acid A′(-H)p, some acidic protons of the acid A′(-H)p might not be deprotonated in a salt with a compound of formula I.

A salt of a protonated compound of formula I and a first anion is also expressed by formulae I-t1-1+, I-t2-1+ or I-t1-2+

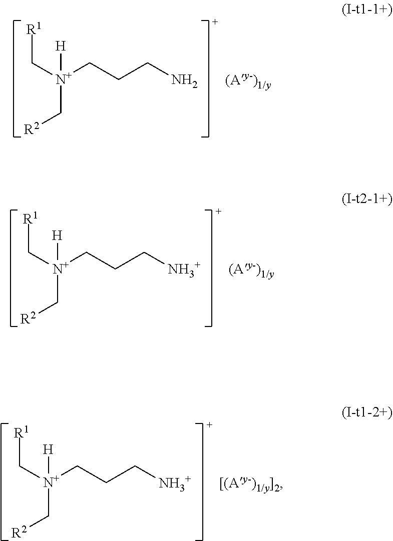

wherein A′ represents the first anion, y is an integer, which is at least 1, and y represents the negative charge of the anion. y is not higher than p, which is the number of acidic protons of the acid A(-H)p. Preferred is an anion, which is a deprotonated acid A(-H)p, wherein p is 1, 2 or 3 and y is 1 for p=1, y is 1 or 2 for p=2 and y is 1, 2, or 3 for p=3. Formulae I-t1-1+ and I-t2-1+ describe tautomeric forms of the same salt.

The first anion is for example C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate, fluorosilicate or a mixture thereof. C₁-C₁₈ carboxylate is for example an aliphatic or olefinic carboxylate, preferably an aliphatic C₁-C₁₃ carboxylate, very preferably an aliphatic C₁-C₆ carboxylate and especially formate, acetate or proprionate. Sulfonate is for example methylsulfonate, ethylsulfonate, propylsulfonate or 1-methylethylsuflonate. Preferably, the sulfonate is an alkyl sulfonate, very preferably a C₁-C₆ sulfonate, particularly a C₁-C₁₃ sulfonate and very particularly methylsulfonate. Preferred is C₁-C₁₈ carboxylate, fluoride, chloride, sulfonate, hydrogensulfate, sulfate, dihydrogenphosphate, hydrogenphosphate, phosphate or nitrate. Very preferred is aliphatic or olefinic C₁-C₁₈ carboxylate, particularly preferred is formate, acetate or proprionate.

Preferred is a method, wherein first anion is C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate, fluorosilicate or a mixture thereof.

The second anion is the deprotonated form of an acid A″(-H)p, wherein —H represents an acidic proton and p the number of acidic protons of the acid A″(-H)p. Depending on the acid strength of the acid A″(-H)p, some acidic protons of the acid A″(-H)p might not be deprotonated in a salt with a compound of formula II.

A salt of a protonated compound of formula II and a second anion is also expressed by formula II-t1-1+

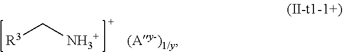

wherein A″ represents the second anion, y is an integer, which is at least 1, and y represents the negative charge of the anion. y is not higher than p, which is the number of acidic protons of the acid A″(-H)p. Preferred is an anion, which is a deprotonated acid A″(-H)p, wherein p is 1, 2 or 3 and y is 1 for p=1, y is 1 or 2 for p=2 and y is 1, 2, or 3 for p=3.

The second anion is for example C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate, fluorosilicate or a mixture thereof. C₁-C₁₈ carboxylate is for example an aliphatic or olefinic carboxylate, preferably an aliphatic C₁-C₁₃ carboxylate, very preferably an aliphatic C₁-C₆ carboxylate and especially formate, acetate or proprionate. Sulfonate is for example methylsulfonate, ethylsulfonate, propylsulfonate or 1-methylethylsuflonate. Preferably, the sulfonate is an alkyl sulfonate, very preferably a C₁-C₆ sulfonate, particularly a C₁-C₃ sulfonate and very particularly methylsulfonate. Preferred is C₁-C₁₈ carboxylate, fluoride, chloride, sulfonate, hydrogensulfate, sulfate, dihydrogenphosphate, hydrogenphosphate, phosphate or nitrate. Very preferred is aliphatic or olefinic C₁-C₁₈ carboxylate, particularly preferred is formate, acetate or proprionate.

Preferred is a method, wherein the second anion is C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate or fluorosilicate.

Preferably, the first anion and the second anion are independently from each other C1-C18 carboxylate, fluoride, chloride, bromide, iodide, sulfonate, hydrogensulfate, sulfate, dihydrogenphosphate, hydrogenphosphate, phosphate, nitrate, hydrofluorosilicate or fluorosilicate.

Preferably, the first anion and the second anion are the same. This includes also that in case of a mixture of specific anions, the mixture is the same.

At step c) in case of the presence of the second amine (B), the weight ratio between the first amine (A) and the second amine (B) is preferably in a range from 0.1 to 10. A weight ratio of 0.1 corresponds to 1 weight part of the first amine (A) and 10 weight parts of the second amine (B). A weight ratio of 10 corresponds to 1 weight part of the first amine and 0.1 weight parts of the second amine (B). Very preferably, the weight ratio between the first amine (A) and the second amine (B) is in a range from 0.15 to 5, particularly in a range from 0.18 to 2, very particularly in a range from 0.2 to 1, especially in a range from 0.25 to 0.7 and very especially in a range from 0.3 to 0.5.

Preferred is a method, wherein at step c), the weight ratio between the first amine (A) and the second amine (B) is in a range from 0.1 to 10.

Preferred is a method, wherein at step c), the weight ratio between the first amine (A) and the second amine (B) is in a range from 0.2 to 1.

The first amine (A) is added preferably in an amount of 10 g to 500 g per ton of the ore. In other words, the weight of the first amine (A) is added in an amount, which is in the range from 10 g to 500 g per ton of the ore. The amount is very preferably from 30 g to 300 g per ton of the ore, particularly preferably from 40 g to 250 g per ton of the ore, especially from 50 g to 200 g per ton of the ore and very especially from 60 g to 160 g per ton of the ore. The overall amount of the first amine (A) can be added at once or in portions.

Preferred is a method, wherein the first amine (A) is added in an amount in the range from 10 g to 500 g per ton of the ore.

In case that the second amine (B) is further added, the first amine (A) and the second amine (B) are added preferably in an amount of 10 g to 500 g per ton of the ore. In other words, the sum of the weights of the first amine (A) and of the second amine (B) is added in an amount, which is in the range from 10 g to 500 g per ton of the ore. The amount is very preferably from 30 g to 300 g per ton of the ore, particularly preferably from 40 g to 250 g per ton of the ore, especially from 50 g to 200 g per ton of the ore and very especially from 60 g to 160 g per ton of the ore. The overall amount of the first amine (A) and the second amine (B) can be added at once or in portions.

Preferred is a method, wherein the sum of the weights of the first amine (A) and of the second amine (B) is added in an amount, which is in the range from 10 g to 500 g per ton of the ore.

Preferably, the first amine and the second amine are added at step (c) together in the form of a composition for a use as a flotation collector. The composition comprises

(A) a first amine, which is a compound of formula I, a salt of a protonated compound of formula I and a first anion or a mixture thereof, and

(B) a second amine, which is a compound of formula II, a salt of a protonated compound of formula II and a first anion or a mixture thereof.

Preferably, the sum of the weights of the first amine (A) and of the second amine (B) in the composition is in the range from 50 wt. % to 100 wt. % based on the overall weight of the composition. Very preferably, the range is from 60 wt. % to 100 wt. %, particularly from 70 wt. % to 100 wt. % and very particularly from 80 wt. % to 95 wt. %.

The pH value at the steps (c) and (d) of the method is preferably adjusted with a pH regulator to a specific pH value, typically to a pH value between 8 and 12, particularly between 9 and 11. A pH regulator is typically a strong base, for example sodium hydroxide, potassium hydroxide, sodium carbonate or potassium carbonate. Preferably, the pH value of the aqueous pulp is between 8 and 12, particularly between 9 and 11. Preferably, step (c), i.e. adding the first amine (A) and the second amine (B) to the aqueous pulp, takes place at a pH value between 8 and 12, particularly between 9 and 11. Preferably, the pH value of the aqueous mixture is between 8 and 12, particularly between 9 and 11. Preferably, step (d), i.e. aerating the aqueous mixture, takes place at a pH value between 8 and 12, particularly between 9 and 11. Preferably, (e), i.e. obtaining the concentrate enriched in iron mineral content, takes place at a pH value between 8 and 12, particularly between 9 and 11. A regulation of the pH value supports that the ore, especially the particles of the ore, exhibit the correct surface charge.

Preferred is a method, wherein the pH value at step (c) is between 8 and 12.

Preferred is a method, wherein the pH value at step (c) and at step (b) is between 8 and 12.

Preferred is a method, wherein the pH value at step (c) and at step (d) is between 8 and 12.

Preferred is a method, wherein the pH value at step (c), at step (b) and at step (d) is between 8 and 12.

Preferred is a method, wherein the pH value at step (c), at step (b), at step (d) and at step (e) is between 8 and 12.

A flotation auxiliary is different to a compound of formula I or a compound of formula II. The flotation auxiliary is for example a depressing agent, a froth regulator, a co-collector or an extender oil.

A depressing agent helps to prevent flotation of an ingredient of the ore, which is not desired to get part of the froth or supports in general the selectivity of the method of manufacturing the concentrate. A depressing agent is for example a hydrophilic polysaccharide, particularly a starch, or sodium silicate. The starch is for example a native starch or a modified starch. A native starch is for example a starch from corn, wheat, oat, barley, rice, millet, potato, pea, tapioca or manioc. The native starch is preferably pregelatinized, i.e. warmed for starch gelatination in an aqueous solution, or caustified, i.e. treated with a strong base, for example NaOH, KOH or Ca(OH)₂, in an aqueous solution. A modified starch is either a degraded starch, which possesses a reduced weight-average molecular weight versus the original starch, a chemically modified starch or a degraded and chemically modified starch. A degradation of starch is for example possible by oxidation or treatment by acid, base or enzymes. The degradation leads typically to an increased content on oligosaccharides or dextrines. A chemical modification is a functionalization of a starch by covalent linkage of a chemical group to the starch. A chemically modified starch is for example obtainable by esterification or etherification of a starch. The esterification of an acid with a starch is for example performed with an anhydride of the acid or a chloride of the acid. The etherification of a starch is for example possible with an organic reagent, which contains a reactive epoxide functionality. Preferred is a depressing agent, which is a starch, very preferably a native starch, particularly a pregelatinized starch or a caustified starch, especially a caustified starch. A depressing agent is preferably added in an amount of 100 to 3000 g per ton of the ore. The calculation is performed on basis of dry ore. The amount is very preferably from 300 g to 2200 g per ton of the ore, particularly preferably from 400 g to 1500 g per ton of the ore, especially from 500 g to 1100 g per ton of the ore and very especially from 550 g to 800 g per ton of the ore.

A froth regulator helps to improve the efficiency of the method of manufacturing by interfering with the froth generation. A froth property is for example the froth height respectively the volume of the froth or the stability of the froth, i.e. the time to collapse after stop of aerating. A froth regulator is for example pine oil, methylisobutyl carbinol, C₆-C₁₂ alcohol, particularly 2-ethylhexanol or hexanol, an alcoholic ester, particularly a mixture comprising 2,2,4-trimethyl-1,3-pentandiolmonoisobutyrate, a distillation residue from an oxo-synthesis of 2-ethylhexanol, terpineol, triethoxybutane, an alkoxylated alcohol, particularly an ethoxylated and/or propoxylated alcohol, polyethylene glycol or polypropylene glycol. Preferably, the method is free of using an alkoxylated alcohol, very preferably free of using an alkoxylated alcohol, polyethylene glycol or polypropylene glycol and particularly free of using a froth regulator. It is still attractive, if the method does not require the addition of a froth regulator.

A co-collector is a surface-active compound, which is different to a compound of formula I or a compound formula II. A co-collector is for example cationic, non-ionic or anionic, preferably cationic or non-ionic and very preferably cationic. A cationic co-collector is for example a secondary or tertiary C₉-C₁₈ alkylamine, which is different to a compound of formula I, 2-(C₉-C₁₈ alkyl-amino)ethyl-1-amine, N′—(C₉-C₁₈ alkyl)propane-1,3-diamine, 3-(C₉-C₁₈ alkoxy)propyl-1-amine, N′-(3-(C₉-C₁₈ alkoxy)propyl)propane-1,3-diamine. A non-ionic co-collector is for example C₉-C₁₅ alkyl alcohol, which is branched, or ethoxylated C₉-C₁₅ alkyl alcohol, which is branched and ethoxylated with 2 to 4 mole ethylene oxide. In case of a co-collector as a flotation auxiliary, the co-collector might be added together with the first amine (A) and the second amine (B). In this case, this part of step (b) occurs simultaneously with step (c). It is still attractive, if the method does not require the addition of a co-collector.

Preferred is a method, at step (b) one or more flotation auxiliaries are added and one of the flotation auxiliaries is a depressing agent, a froth regulator, a co-collector or an extender oil.

Preferred is a method, wherein a depressing agent is added as a flotation auxiliary and the depressing agent is a starch.

In the method of manufacturing a concentrate, conventional inverse flotation plant equipment may be used. Preferably, the first amine (A) and optionally a flotation auxiliary, which is a co-collector, is or are added to the aqueous pulp, which is already in the flotation cell, which is used for aerating the mixture in step (d). Preferably, the first amine (A) and the second amine (B) and optionally a flotation auxiliary, which is a co-collector, are added to the aqueous pulp, which is already in the flotation cell, which is used for aerating the mixture in step (d).

After adding of a first amine (A) to the aqueous pulp, the obtained aqueous mixture is preferably kept, particularly under stirring, for a conditioning period before aerating the aqueous mixture. This allows the first amine (A) and optionally a flotation auxiliary, which is a co-collector, to condition the ore, particularly the ore particles, in the aqueous mixture. Similarly, after adding of a first amine (A) and a second amine (B) to the aqueous pulp, the obtained aqueous mixture is preferably kept, particularly under stirring, for a conditioning period before aerating the aqueous mixture. This allows the first amine (A) and the second amine (B) and optionally a flotation auxiliary, which is a co-collector, to condition the ore, particularly the ore particles, in the aqueous mixture. The conditioning period lasts for example for one minute or up to 10 or 15 minutes.

At aerating the aqueous mixture, air is typically injected into the base of the flotation cell. Air bubbles are formed and rise to the surface and generate the froth at the surface. The injection of air may be continued until no more froth is formed. This might last for example for one minute or up to 15 or 20 minutes. The froth is removed.

For obtaining the concentrate enriched in iron mineral content, aerating is typically stopped. The concentrate enriched in iron mineral content sinks typically to the bottom of the flotation cell.

In some cases, it may be desirable to treat the concentrate enriched in iron mineral content in a similar manner again. For example, the steps (c) and (d) are repeated as step (d-c) followed by step (d-d) before step (e) is conducted.

The concentrate enriched in iron mineral content contains preferably at least 60% by weight of Fe atoms based on the overall weight of the concentrate enriched in iron mineral content, very preferably at least 65% by weight. The weight of Fe atoms is similar to the weight of iron content. The concentrate enriched in iron mineral content contains preferably less than 2.5% by weight of SiO2 based on the overall weight of the concentrate enriched in iron mineral, very preferably less than 2.1% by weight and particularly preferably 2.0% or less than 1.9% by weight of SiO2. The concentrate enriched in iron mineral content contains preferably at least 60% by weight of Fe atoms and less than 2.5% by weight of SiO2 based on the overall weight of the concentrate enriched in iron mineral content, very preferably at least 65% by weight of Fe atoms and less than 2.1% by weight of SiO2.

The above described preferences for the method of manufacturing a concentrate with its added first amine (A) and preferably the first amine (A) and the second amine (B) are described for the method. These preferences apply also to the further embodiment of the invention.

A further embodiment of the invention is a use of a first amine (A) as a flotation collector for manufacturing a concentrate enriched in iron mineral content from an ore, which contains an iron mineral and silicate, by a reverse flotation, characterized in that the first amine is

(A) a compound of formula I

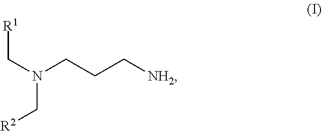

wherein R¹ and R² are independently from each other methyl, ethyl, propyl, 1-methyl-ethyl, butyl, pentyl, hexyl, heptyl or 2-methyl-hexyl, a salt of a protonated compound of formula I and a first anion or a mixture thereof.

Preferably, the use comprises adding the first amine to a prepared aqueous pulp of the ore and optionally one or more flotation auxiliaries to obtain an aqueous mixture.

Preferred is a use, wherein a combination of the first amine (A) and a second amine (B) is used as a flotation collector for manufacturing a concentrate enriched in iron mineral content from an ore, which contains an iron mineral and silicate, by a reverse flotation, and the second amine (B) is a compound of formula II

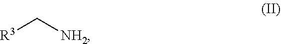

wherein R³ is a C5-C17 alkyl, which is branched or linear, or a C5-C17 alkenyl, which is branched or linear, a salt of a protonated compound of formula II and a second anion or a mixture thereof.

Accordingly, the first amine (A) and the second amine (B) are preferably used together as a flotation collector.

Preferably, the use comprises adding the first amine and the second amine to a prepared aqueous pulp of the ore and optionally one or more flotation auxiliaries to obtain an aqueous mixture.

A further embodiment of the invention is a composition for a use as a flotation collector, which comprises

(A) a first amine, which is a compound of formula I

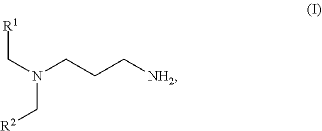

wherein R¹ and R² are independently from each other methyl, ethyl, propyl, 1-methyl-ethyl, butyl, pentyl, hexyl, heptyl or 2-methyl-hexyl, a salt of a protonated compound of formula I and a first anion or a mixture thereof, and

(B) a second amine, which is a compound of formula II

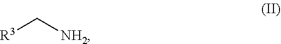

wherein R³ is a C5-C17 alkyl, which is branched or linear, or a C5-C17 alkenyl, which is branched or linear, a salt of a protonated compound of formula II and a first anion or a mixture thereof,

wherein the weight ratio between the first amine (A) and the second amine (B) is in a range from 0.2 to 1.

Preferably the composition for a use as a flotation collector according to the present invention is a water-soluble composition.

Preferred is a composition for a use as a flotation collector, wherein the sum of the weights of the first amine (A) and of the second amine (B) is in the range from 50 wt. % to 100 wt. % based on the overall weight of the composition.

The following examples illustrate further the invention without limiting it. Percentage values are percentage by weight if not stated differently.

A) Employed Chemicals
A-1: Flotigam EDA (RTM, Clariant Ltd), a branched C9-C12 ethermonoamine acetate
A-2: 2-ethylhexan-1-amine [CAS-No. 104-75-6], 50 mol % neutralized with acetic acid [acetate salt CAS-No. 67785-97-1]
A-3: N′,N′-dibutylpropane-1,3-diamine [CAS-No. 102-83-0], 50 mol % neutralized with acetic acid
A-4: blend of 75 wt. % A-2 and 25 wt. % A-3
A-5: N′,N′-dibutylethane-1,2-diamine [CAS-No. 3529-07-7], 50 mol % neutralized with acetic acid
A-6: 3-(N-Octylamino)propyl-1-amine [CAS-No. 7173-57-1]
   St-1: causticized starch
   6 g corn starch and 52 g of distilled water are added in a 600 mL beaker. 2 g of an aqueous 50 wt. % NaOH solution is added and energetically mixed for 10 minutes until it acquires a gel appearance. 140 g of distilled water are added to the mixture and a homogenization is made with a magnetic stirrer for 5 minutes.

B) Calculation of Selectivity

A measure of selectivity for the valuable mineral and against the gangue can be Separation Efficiency (SE) defined as SE=Rv−RG, with Rv being recovery of the valuable element and RG being the recovery of gangue as described in “Separation Efficiency” by Norman F. Schulz, Society of Mining Engineers of AIME, pre-print No. 69-B-44, paper to be presented at the Annual Meeting of the American Institute of Mining, Metallurgical and Petroleum Engineers, Washington, D.C., 1969 (available in digitalized form for example at www.911metallurgist.com/separation-efficiency/). The same calculation can be made from element assays of the concentrate and tailings fraction and represented as

$$SE = 100 \frac{{c}_{m}}{f} [ \frac{( f - t ) ( c - f )}{( c - t ) ( {c}_{m} - f )} ] = 100 \frac{f - t}{c - t} [ \frac{c}{f} - \frac{{c}_{m} - c}{{c}_{m} - f} ]$$

where

c: atom content of desired element [wt. %] in the concentrate
cm: atom content of desired element [wt. %] in the mineral being concentrated
f: atom content of desired element [wt. %] in the feed
t: atom content of desired element [wt. %] in the tailings

The value of Separation Efficiency for an ideal separation is 100, however the real values are below that. The closer it is to 100, the better the separation and the recovery of valuable element.

In case of itabirite ore, the desired element is iron (Fe) and the mineral being concentrated is haematite Fe2O3 with an atom content of iron in the mineral of 69.9%. The gangue in an itabirite ore consists predominantly of quartz (SiO2), which is determined as Si by WDXRF and recalculated as SiO2 in the concentrate. For a calculation of Separation Efficiency, only the iron content of the fraction is used.

C) Flotation

C-1: Flotation of a First Itabirite Type Iron Ore

A first itabirite type iron ore (45.03 wt. % Fe and 35.36 wt. % SiO2) with iron mainly contained as haematite is ground to a particle size distribution as shown in table C-1-1.

TABLE C-1-1
particle size distribution of ground itabirite type iron ore

| | | | | | |
|---|---|---|---|---|---|
| size range [μm] | >150 | 150-106 | 105-76 | 75-38 | <38 |
| wt. fraction [%] | 6.4 | 10.1 | 18.8 | 16.8 | 47.9 |

500 g ground itabirite type iron ore and 400 mL distilled water are placed in a 1.5 L flotation cell in a CDC flotation machine and agitated at 1000 rpm. The slurry is conditioned with the causticized starch solution St-1 corresponding to 665 g starch per ton of dry ore for 5 min. The pH is raised to 10.2 using an aqueous 5 wt. % NaOH solution. Subsequently, 7.5 g of an aqueous 1 wt. % solution of a collector as listed in table C-1-2, which corresponds to 150 g per ton of dry ore, is added to the slurry and conditioned for 1 min. After conditioning, further 550 mL distilled water is added and the slurry aerated at 1 L/min until the completion of the flotation (3 min). The froth fraction is collected and aeration is stopped. The water level is maintained during the entire flotation time. The remaining cell fraction (further described as concentrate) and the separated froth were dried in an oven at 100° C., weighed, homogenized, and their contents of Fe and Si are determined using WDXRF in a lithium borate fused bead matrix. The Si content is recorded as SiO2. The results are listed in table C-1-2.

TABLE C-1-2

| | | | | | Fe | | | |
|---|---|---|---|---|---|---|---|---|
| | | | amount | Fe re- | conc. | Si recovery | SiO₂ | |
| | | | of caus- | covery ^{c)} | grade ^{d)} | into con- | conc. | |
| | | amount | ticized | [Fe | [Fe | centrate ^{e)} | grade ^{f)} | separa- |
| | | of col- | corn | atom | atom | [Si atom | [SiO₂ | tion ef- |
| example | col- | lector | starch | weight | weight | weight in | weight in | ficiency |
| No. | lector | [g/t] | St-1 [gv/t] | in %] | in %] | %] | %] | [%] |
| C-1-1 ^{a)} | A-1 | 150 | 665 | 65 | 68 | 1.5 | 1.3 | 64 |
| C-1-2 ^{a)} | A-2 | 150 | 665 | 61 | 69 | 1.0 | 0.9 | 62 |
| C-1-3 ^{b)} | A-3 | 150 | 665 | 77 | 68 | 1.6 | 1.1 | 75 |
| C-1-4 ^{b)} | A-4 | 150 | 665 | 88 | 66 | 2.0 | 1.4 | 82 |

Footnotes:
^{a)} comparative
^{b)} according to invention
^{c)} Fe recovery is the ratio between the overall amount of Fe atom contained in the cell fraction and the overall amount of Fe atom contained in the ore employed as starting material
^{d)} Fe conc. grade means Fe atom content in cell fraction
^{e)} Si recovery is the ratio between the overall amount of Si atom contained in the cell fraction and the overall amount of Si atom contained in the ore employed as starting material
^{f)} SiO2 conc. grade means SiO2 content in cell fraction

The results in table C-1-2 shows that example C-1-4 with its two collectors shows a significantly increased Fe recovery, which is much higher than would be expected from the Fe recoveries of the single collectors at examples C-1-2 and C-1-3. In addition, the SiO2 content stays at a low level, which is in a range as expected from the two single collectors. This is remarkable in view of the significantly increased Fe recovery and leads to the best separation efficiency. Example C-1-3 with its single collector shows still a remarkable separation efficiency.

C-2: Flotation of a Second Itabirite Type Iron Ore

A second itabirite type iron ore (38.4 wt. % Fe and 41.0 wt. % SiO2) with iron mainly contained as haematite is ground to a particle size distribution as shown in table C-2-1.

TABLE C-2-1
particle size distribution of ground itabirite type iron ore

| | | | | | | | |
|---|---|---|---|---|---|---|---|
| size range [μm] | >400 | 400-213 | 212-151 | 150-107 | 106-64 | 63-38 | <38 |
| wt. fraction [%] | 0.7 | 0.3 | 3.9 | 8.1 | 21.2 | 25.0 | 40.8 |

500 g ground itabirite type iron ore and 400 mL tap water from Ludwigshafen are placed in a 1.2 L flotation cell in a Denver D12 flotation machine and agitated at 1200 rpm. The slurry is conditioned with causticized starch solution St-1 corresponding to 560 g starch per ton of dry ore for 5 min. The pH is raised to 10.5 using an aqueous 10 wt. % NaOH solution. Subsequently, 3.75 mL of an aqueous 1 wt. % solution of a collector as listed in table C-2-2, which corresponds to 75 g per ton of dry ore, is added to the slurry and conditioned for 3 min. After conditioning, further 250 mL tap water from Ludwigshafen is added and the slurry aerated at 100 L/h until the completion of the flotation (3 min). The froth fraction is collected and aeration is stopped. The water level is maintained during the entire flotation time. The pH is reset to 10.5 using aqueous 10 wt. % NaOH solution. 1.25 mL collector solution as above, corresponding to 25 g collector per ton of initial dry ore, are added to the slurry. A subsequent aeration at 100 L/h results in flotation of additional froth phase which is collected in a fresh tray.

The remaining cell fraction (concentrate) and separated froth fractions are dried in an oven at 70° C., weighed, homogenized, and their content of Fe and Si is determined using WDXRF in a lithium borate fused bead matrix. The Si content is recorded as SiO2. The results are listed in table C-2-2.

TABLE C-2-2

| | | | | | Fe | | | |
|---|---|---|---|---|---|---|---|---|
| | | | amount | Fe re- | conc. | Si recovery | SiO₂ | |
| | | | of caus- | covery ^{c)} | grade ^{d)} | into con- | conc. | |
| | | amount | ticized | [Fe | [Fe | centrate ^{e)} | grade ^{f)} | separa- |
| | | of col- | corn | atom | atom | [Si atom | [SiO₂ | tion ef- |
| example | col- | lector | starch | weight | weight | weight in | weight in | ficiency |
| No. | lector | [g/t] | St-1 [g/t] | in %] | in %] | %] | %] | [%] |
| C-2-1 ^{a)} | A-1 | 75 + 25 | 560 | 82 | 66 | 0.5 | 0.5 | 76 |
| C-2-2 ^{a)} | A-2 | 75 + 25 | 560 | 85 | 63 | 10.0 | 8.1 | 73 |
| C-2-3 ^{b)} | A-3 | 75 + 25 | 560 | 83 | 66 | 0.5 | 0.4 | 78 |
| C-2-4 ^{b)} | A-4 | 75 + 25 | 560 | 87 | 86 | 1.6 | 1.4 | 81 |

Footnotes:
^{a)} comparative
^{b)} according to invention
^{c)} Fe recovery is the ratio between the overall amount of Fe atom contained in the cell fraction and the overall amount of Fe atom contained in the ore employed as starting material
^{d)} Fe conc. grade means Fe atom content in cell fractione) Si recovery is the ratio between the overall amount of Si atom contained in the cell fraction and the overall amount of Si atom contained in the ore employed as starting material
^{f)} SiO2 conc. grade means SiO2 content in cell fraction

The results in table C-2-2 shows that example C-2-4 with its two collectors shows an increased Fe recovery, which is higher than would be expected from the Fe recoveries of the single collectors at examples C-2-2 and C-2-3. In addition, the SiO2 content stays at a low level, which would not have been expected from the single collector A-2 at example C-2-2. This is remarkable in view of the increased Fe recovery and leads to the best separation efficiency. Example C-2-3 with its single collector shows still a remarkable separation efficiency.

C-3: Flotation of a Third Itabirite Type Iron Ore

A third itabirite type iron ore (40.3 wt. % Fe and 40.6 wt. % SiO2) containing minor amounts of muscovite (KAl2(OH,F)2[AlSi3O10]) and kaolinite (A14[(OH)8[Si4O10]), with iron mainly contained as haematite, is ground to a particle size distribution as shown in table C-3-1.

TABLE C-3-1
particle size distribution of ground itabirite type iron ore

| | | | | | | | |
|---|---|---|---|---|---|---|---|
| size range [μm] | >400 | 400-213 | 212-151 | 150-107 | 106-64 | 63-38 | <38 |
| wt. fraction [%] | <0.1 | 1.8 | 6.1 | 9.2 | 20.7 | 22.0 | 40.1 |

500 g ground ore and 400 mL Ludwigshafen tap water are placed in a 1.2 L transparent plexiglass flotation cell in a Denver D12 flotation machine and agitated at 1200 rpm. The slurry is conditioned with causticized starch solution St-1 corresponding to 560 g starch per ton of dry ore for 5 min. The pH is raised to 9.8 using an aqueous 10 wt. % NaOH solution. Subsequently, 3.75 mL of an aqueous 1 wt. % solution of a collector as listed in table C-3-2, which corresponds to 75 g per ton of dry ore, is added to the slurry and conditioned for 3 min. After conditioning, further 250 mL Ludwigshafen tap water is added and the slurry is aerated at 100 L/h until the completion of the flotation (3 min). The froth fraction is collected in a tray. The pH is monitored and maintained within the range of 9.4 to 9.7 by dropwise addition of aqueous 10 wt. % NaOH solution as necessary. The water level is maintained approximately constant during the entire flotation time. After the completion of froth formation, the pH is reset to 9.8 using an aqueous 10 wt. % NaOH solution. 1.25 mL of an aqueous 1 wt. % aqueous solution of a collector as listed in table C-3-2, which corresponds to 25 g per ton of initial dry ore, is added to the pulp and conditioned at 1200 rpm for 1 min. Subsequently the froth is aerated at 100 L/h until the completion of the flotation (appr. 2.5 min). The aeration is stopped. The remaining cell fraction (concentrate) and combined froth fractions are dried in an oven at 70° C., weighed, homogenized, and their contents of Fe and Si are determined using WDXRF in a lithium borate fused bead matrix. The Si content is recorded as SiO2. The results are listed in table C-3-2.

TABLE C-3-2

| | | | | | Fe | | | |
|---|---|---|---|---|---|---|---|---|
| | | | amount | Fe re- | conc. | Si recovery | SiO₂ | |
| | | | of caus- | covery ^{c)} | grade ^{d)} | into con- | conc. | |
| | | amount | ticized | [Fe | [Fe | centrate ^{e)} | grade ^{f)} | separa- |
| | | of col- | corn | atom | atom | [Si atom | [SiO₂ | tion ef- |
| Example | col- | lector | starch | weight | weight | weight in | weight in | ficiency |
| No. | lector | [g/t] | St-1 [g/t] | in %] | in %] | %] | %] | [%] |
| C-3-1 ^{b)} | A-3 | 75 + 25 | 560 | 77 | 68 | 1.0 | 0.9 | 74 |
| C-3-2 ^{a)} | A-5 | 75 + 25 | 560 | 69 | 67 | 3.9 | 3.7 | 85 |

Footnotes:
^{a)} comparative
^{b)} according to invention
^{c)} Fe recovery is the ratio between the overall amount of Fe atom contained in the cell fraction and the overall amount of Fe atom contained in the ore employed as starting material
^{d)} Fe conc. grade means Fe atom content in cell fraction
^{e)} Si recovery is the ratio between the overall amount of Si atom contained in the cell fraction and the overall amount of Si atom contained in the ore employed as starting material
^{f)} SiO2 conc. grade means SiO2 content in cell fraction

The results in table C-3-2 shows that example C-3-1 with its single collector A-3 shows an increased Fe recovery in comparison to example C-3-2 with its single collector A-5. In addition, the SiO2 content is lower. Both contribute to a better separation efficiency. This is remarkable in view of the structural difference between A-3 and A-5 is only an additional CH₂-unit at A-3, i.e. A-3 is a propylene-1,3-diamine derivative and A-5 is an ethylene-1,2-diamine derivative.

C-4: Flotation of a Fourth Itabirite Type Iron Ore

A fourth itabirite type ore (41.9% Fe and 41.0% SiO2) containing minor amount of kaolinite and muscovite (<2% each), with iron mainly contained as haematite, is ground to a particle size distribution as shown in table C-4-1.

TABLE C-4-1
particle size distribution of ground itabirite type iron ore

| | | | | | | | |
|---|---|---|---|---|---|---|---|
| size range [μm] | 400-213 | 212-151 | 150-107 | 106-90 | 89-64 | 63-38 | <38 |
| wt. fraction [%] | 1.8 | 6.1 | 9.2 | 5.3 | 15.4 | 22 | 40.1 |

500 g ground ore and 400 mL Ludwigshafen tap water are placed in an 1.2 L transparent plexiglass flotation cell in a Denver D12 flotation machine and agitated at 1200 rpm. The slurry is conditioned with causticized starch solution as prepared above, corresponding to 560 g starch per ton of solid ore, for 5 min. The pH was raised to 9.8 using a 10 wt % aqueous NaOH solution. Subsequently, 1 wt % aqueous solution of a collector is added to the slurry and conditioned for 3 min.

After conditioning, further 250 mL Ludwigshafen tap water is added and the slurry is aerated at 100 L/h until the completion of the flotation (3 min). The froth fraction is collected in a tray. The pH is monitored and maintained within the range of 9.4-9.7 by dropwise addition of 10% wt NaOH solution as necessary. The water level was maintained approximately constant during the entire flotation time.

After the completion of froth formation, aeration is stopped. The remaining cell fraction (further described as concentrate) and froth fraction are dried in an oven at 70° C., weighed, homogenized, and their content of Fe and Si are determined using WDXRF in a lithium borate fused bead matrix. The Si content is recorded as SiO2. The results are listed in table C-4-2.

TABLE C-4-2

| | | | amount | | | | Si recovery | SiO₂ | |
|---|---|---|---|---|---|---|---|---|---|
| | | | of caus- | Fe re- | Fe conc. | Fe conc. | into con- | conc. | |
| | | amount | ticized | covery ^{c)} | grade ^{d.1)} | grade in tail- | centrate ^{e)} | grade ^{f)} | separa- |
| | | of col- | corn | [Fe atom | [Fe atom | ings ^{d.2)} [Fe | [Si atom | [SiO₂ | tion ef- |
| example | col- | lector | starch | weight | weight | atom weight | weight in | weight in | ficiency |
| No. | lector | [g/t] | St-1 [g/t] | in %] | in %] | in %] | %] | %] | [%] |
| C-4-1 ^{b)} | A-3 | 75 | 560 | 83.0 | 66.8 | 13.2 | 1.6 | 1.4 | 72.8. |
| C-4-2 ^{b)} | A-4 | 75 | 560 | 86.9 | 65.76 | 10.02 | 12.4 | 9.2 | 81.0 |
| C-4-3 ^{a)} | A-5 | 75 | 560 | 74.5 | 65.30 | 19.28 | 7.1 | 6.1 | 66.9 |
| C-4-4 ^{a)} | A-6 | 75 | 560 | 37.1 | 68.63 | 34.13 | ~0 | 0.2 | 29.7 |

Footnotes:
^{a)} comparative
^{b)} according to invention
^{c)} Fe recovery is the ratio between the overall amount of Fe atom contained in the cell fraction and the overall amount of Fe atom contained in the ore employed as starting material
^{d.1)} Fe conc. grade means Fe atom content in cell fraction
^{d.2)} Fe conc. grade means Fe atom content in tailing fraction
^{e)} Si recovery is the ratio between the overall amount of Si atom contained in the cell fraction and the overall amount of Si atom contained in the ore employed as starting material
^{f)} SiO2 conc. grade means SiO2 content in cell fraction

The results in table C-4-2 shows that example C-4-1 with its single collector A-3 shows an increased Fe recovery in comparison to example C-4-3 with its single collector A-5. In addition, the SiO2 content is lower. Both contribute to a better separation efficiency. As mentioned already above for example C.3, this is remarkable in view of the structural difference between A-3 and A5. Further, A-6 is a powerful but unselective silica collector resulting in high grade iron concentrate but very high iron losses into tailings.

I/We claim:

1. A method for manufacturing a concentrate enriched in iron mineral content from an ore, which contains an iron mineral and silicate, by a reverse flotation, which the method comprising:
(c) adding a first amine to a prepared aqueous pulp of the ore and optionally one or more flotation auxiliaries to obtain an aqueous mixture,
wherein the first amine is
(A) a compound of formula I 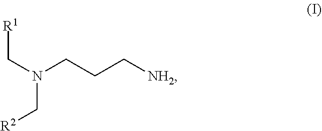
wherein R¹ and R² are independently from each other methyl, ethyl, propyl, 1-methyl-ethyl, butyl, pentyl, hexyl, heptyl or 2-methyl-hexyl, a salt of a protonated compound of formula I and a first anion or a mixture thereof.

2. The method according to claim 1, further comprising:
(a) providing the ore, which contains an iron mineral and silicate,
(b) preparing from the provided ore by addition of water and optionally one or more flotation auxiliaries an aqueous pulp,
(c) adding
the first amine to the prepared aqueous pulp of the ore and optionally one or more flotation auxiliaries to obtain an aqueous mixture,
(d) aerating the aqueous mixture in a flotation cell to generate a froth, which is enriched in silicate content, and removing the generated froth from the flotation cell, and
(e) obtaining from the flotation cell the concentrate enriched in iron mineral content.

3. The method according to claim 1, wherein
at (c) a second amine is further added, wherein the second amine is
(B) a compound of formula II 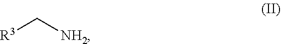
wherein R³ is a C₅-C₁₇ alkyl, which is branched or linear, or a C₅-C₁₇ alkenyl, which is branched or linear, a salt of a protonated compound of formula II and a second anion or a mixture thereof, or
wherein is a C₇-C₁₂ alkyl, which is branched or linear, or
wherein R³ is 1-ethyl-pentyl,
optionally, wherein the weight ratio between the first amine (A) and the second amine (B) is in a range from 0.1 to 10.

4. The method according to claim 1, wherein R¹ and R² are independently from each other methyl, ethyl, propyl, 1-methyl-ethyl, butyl or pentyl.

5. The method according to claim 1, wherein R¹ and R² are the same.

6. (canceled)

7. The method according to claim 1, wherein R¹ and R² are propyl.

8-10. (canceled)

11. The method according to claim 1, wherein the first anion is C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate, fluorosilicate or a mixture thereof.

12. The method according to claim 3, wherein the second anion is C₁-C₁₈ carboxylate, fluoride, chloride, bromide, iodide, sulfonate, hydrogensulfate, sulfate, dihydrogenphosphate, hydrogenphosphate, phosphate, nitrate, hydrofluorosilicate, fluorosilicate or a mixture thereof.

13. The method according to claim 1, wherein the first amine (A) is added in an amount in the range from 10 g to 500 g per ton of the ore.

14. The method according to claim 3, wherein the sum of the weights of the first amine (A) and of the second amine (B) is added in an amount in the range from 10 g to 500 g per ton of the ore.

15. The method according to claim 1, wherein the pH value at step (c) is between 8 and 12.

16. The method according to claim 1, wherein the ore contains iron atoms in the range of 20 wt. % to 55 wt. % based on the weight of the ore.

17. The method according to claim 1, wherein all iron minerals in the ore are non-sulfidic iron minerals.

18. The method according to claim 1, wherein the iron mineral in the ore contains an iron oxide, or
wherein the iron mineral contains hematite, magnetite or goethite or a mixture of two or three thereof.

19. (canceled)

20. The method according to claim 1, wherein at (b) one or more flotation auxiliaries are added and one of the flotation auxiliaries is a depressing agent, a froth regulator, a co-collector or an extender oil,
optionally, wherein a depressing agent is added as a flotation auxiliary and the depressing agent is a starch.

21. (canceled)

22. A method of using a first amine (A) as a flotation collector for manufacturing a concentrate enriched in iron mineral content from an ore, comprising:
combining the first amine (A) with the ore to form a combination, wherein the ore comprises an iron mineral and silicate;
performing a reverse flotation process using the combination to form the concentrate,
wherein the first amine (A) is a compound of formula I, a salt of a protonated compound of formula I and a first anion or a mixture thereof as defined in claim 1.

23. The method of claim 22, wherein a combination of the first amine (A) and a second amine (B) is used as the flotation collector, and the second amine (B) is a compound of formula II, a salt of a protonated compound of formula II or a mixture thereof as defined in claim 3.

24. A non-adhesive composition for a use as a flotation collector, comprising:
(A) a first amine, which is a compound of formula I 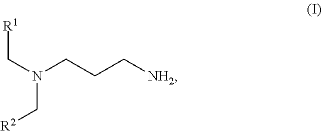
wherein R¹ and R² are independently from each other methyl, ethyl, propyl, 1-methyl-ethyl, butyl, pentyl, hexyl, heptyl or 2-methyl-hexyl, a salt of a protonated compound of formula I and a first anion or a mixture thereof as defined in claim 1, and
(B) a second amine, which is a compound of formula II 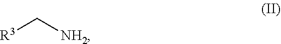
wherein R³ is a C₅-C₁₇ alkyl, which is branched or linear, or a C₅-C₁₇ alkenyl, which is branched or linear, a salt of a protonated compound of formula II and a first anion or a mixture thereof,
wherein the weight ratio between the first amine (A) and the second amine (B) is in a range from 0.2 to 1.

25. The composition according to claim 24, wherein the composition is water-soluble.

26. The composition according to claim 24, wherein the sum of the weights of the first amine (A) and of the second amine (B) is in the range from 50 wt. % to 100 wt. % based on the overall weight of the composition.
